(19) United States
(12) Patent Application Publication
(10) Pub. No.: US 2014/0074890 A1
(43) Pub. Date: Mar. 13, 2014

(54) METHOD OF SYNCHRONOUSLY PROVIDING DATA FROM SOFTWARE AND WEBSITE

(71) Applicant: PEI SHIN CHANG, TAICHUNG CITY 408 (TW)

(72) Inventor: PEI SHIN CHANG, TAICHUNG CITY 408 (TW)

(73) Assignee: LUNG CHENG TECHNOLOGY LTD., TAICHUNG CITY (TW)

(21) Appl. No.: 13/613,132

(22) Filed: Sep. 13, 2012

(51) Int. Cl. G06F 17/30

(52) U.S. Cl. 707/784; 707/E17.134

(57) ABSTRACT

A method of synchronously providing data from software and a website is applied in the software installed to the website, and the software creates a database, and the method includes the following steps: a user end enters into the website via a network to login the software; the user end applies for an access of the software; the software sets an authorization level of the user end; the user end obtains the access of the software; the user end creates one or more records of data in the database by the software; the user end sets an authorization level for retrieving and storing the data by the software; and the software retrieves the retrievable data from the database according to the authorization level of each user end and produces a webpage to output the retrieved data.

### FIELD OF THE INVENTION

The present invention relates to a method of providing data from software and website, more particularly to the method of combining a database of software with a website to provide data of the databases to the website.

### BACKGROUND OF THE INVENTION

In general, data created on a website can be browsed by an inquirer from a first database installed in a computer or situated in cloud computing software, and the software is provided for inputting data into the first database, and then transmitting and storing the data into a second database of a network platform provided by an Internet service provider (ISP) via the Internet, and an other website program is designed and coded for reading the data from the second database and displaying the data on a webpage for the inquirer's viewing.

In the aforementioned method, the first and second databases are not connected directly, and data can be updated via network transmissions only, and thus resulting in the drawbacks of complicated processing procedure and inconvenience. In addition, either coding or purchasing the website program for reading the data of the second database incurs higher costs and requires follow-up maintenance.

### SUMMARY OF THE INVENTION

Therefore, it is a primary objective of the present invention to provide a method of synchronously providing data from software and website that combines database of software and a website to achieve the effects of simplifying the processing procedure and lowering the website installation and maintenance costs.

To achieve the foregoing objective, the present invention provides a method of synchronously providing data from software and website, and the method is applied to software installed in a website, and the software creates a database, and the method comprises the following steps: a user end enters into the website via a network to logon the software; the user end applies for an access of the software; the software sets an authorization level of the user end; the user end obtains the access of the software; the user end creates one or more records of data in the database by the software; the user end sets an authorization level for retrieving and storing the data by the software; and the software retrieves the retrievable data from the database according to the authorization level of each user end, and produces a webpage to output the retrieved data.

### BRIEF DESCRIPTION OF THE DRAWINGS

FIG. 1 is a schematic block diagram of a preferred embodiment of the present invention;

FIG. 2 is a flow chart of a method of synchronously providing data from software and website in accordance with the present invention; and

FIG. 3 is a schematic block diagram of another preferred embodiment of the present invention.

### DESCRIPTION OF THE PREFERRED EMBODIMENTS

In the method of synchronously providing data from software and website in accordance with the present invention, a website and a database of software are combined, and the software is provided for creating data into the database, and then the data in the database are retrieved and provided for the user's browsing.

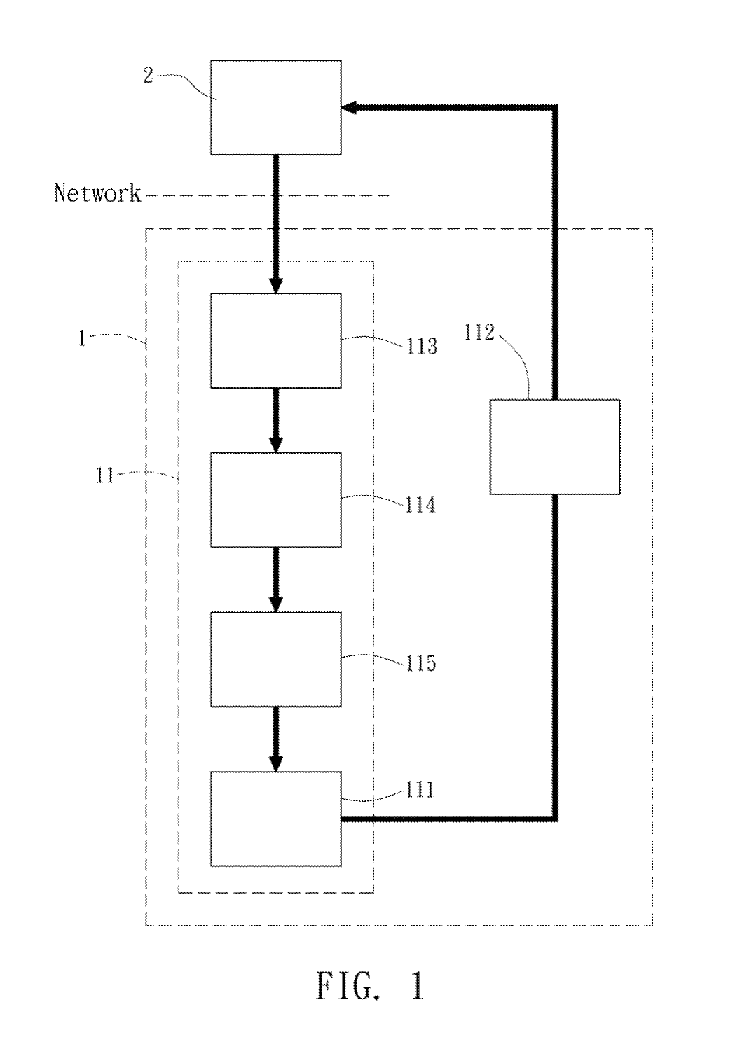

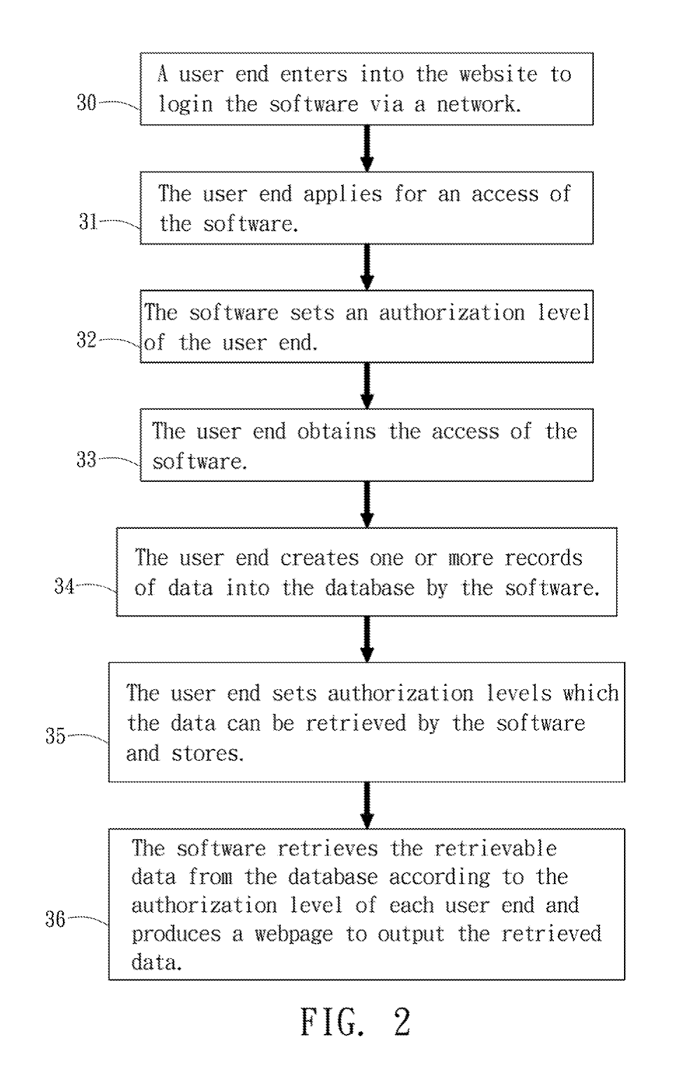

With reference to FIGS. 1 and 2 for a schematic block diagram and a flow chart of a method of synchronously providing data from software and website in accordance with a preferred embodiment of the present invention, the method is applied in software 11 of a website 1, and the software 11 creates a database 111, and the method executes each of the following steps by the software 11. The method comprises the steps as described below.

Step (30): A user end 2 enters into the website 1 via a network to login the software 11.

Step (31): The user end 2 applies for an access of the software 11.

Step (32): The software 11 sets an authorization level of the user end 2.

Step (33): The user end 2 obtains the access of the software 11.

Step (34): The user end 2 creates one or more records of data into the database 111 by the software.

Step (35): The user end 2 sets an authorization level of retrieving and storing data by the software 11.

Step (36): The software 11 retrieves the retrievable data from the database 111 according to the authorization level of each user end 2 and produces a webpage 112 to output the retrieved data.

In this preferred embodiment, the software 11 comprises a login unit 113, and the user end 2 can apply to the login unit 113 for an access of the software 11, and the login unit 113 of the software 11 according to an authorization level set for the identity of the user end 2 (wherein each authorization level is defined to be an authorization level with different priorities in this preferred embodiment), and related login information such as a user name and a password are created in the database 111, such that the user end 2 can login with the correct login information to obtain the access of the software 11 and run the software 11.

The software 11 generates a form interface 114 comprised of a plurality of data fields and provided for the user end 2 to input corresponding data into each data field. After the software 11 inputs the data, the data will be stored into the database 111. In addition, the software 11 includes an authorization reading unit 115, so that when the user end 2 of each authorization level creates data into the database 111 by the software 11, the user end 2 can use the authorization reading unit 115 to set the authorization level for retrieving the retrievable data, so that each authorization level can retrieve the data created by the same or lower authorization level. In other words, a higher authorization level can retrieve data created by the same or lower authorization level from the database 111 by the software 11. On the other hand, a lower authorization level cannot retrieve the data created by a high authorization level. Further, the software 11 produces a webpage 112, and the fields displayed on the webpage 112 directs to corresponding data in the database 111 and provided for the browsing and inquiry by the user end 2.

It is noteworthy that the database 111 is created by the software 11, and the data are created into the database 111 through the software 11 by the user end 2, and the software 11 synchronously shows the data created into the database 111 by the user end 2 in form of the webpage 112 for the browsing by the user end 2, without requiring the synchronous transmissions of data to the software 11 and the website 1 through the Internet, so as to achieve the effects of simplifying the processing procedure, and saving the cost of coding or purchasing the website program.

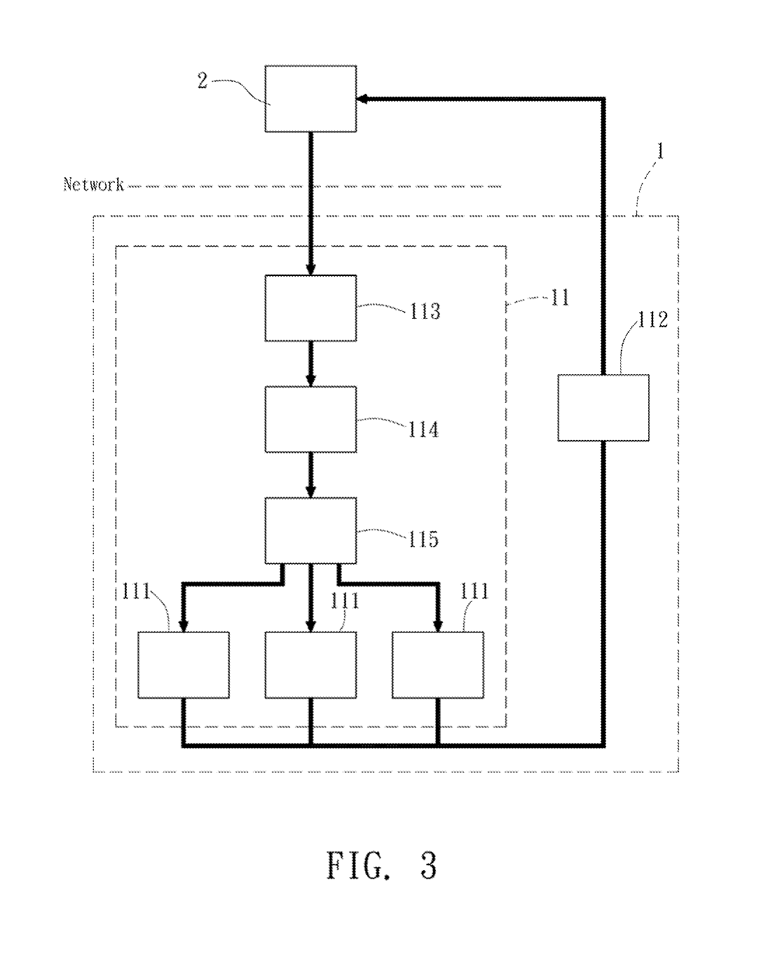

With reference to FIG. 3 for another preferred embodiment, the software 11 creates two or more databases 111, and the plural records of data created by the user end 2 are stored into each database 111 separately and outputted to the webpage 112 by the software 11 at the same time, wherein the displayed fields direct to the databases 111 respectively and display the corresponding retrieved data for browsing and inquiry by the user end 2. This method stores the data separately and provides the advantage of reducing the risk of data storage.

What is claimed is:

1. A method of synchronously providing data from software and website, applied in software installed to a website, and the software creating a database, and the method comprising the steps of:
a user end entering into the website via a network to login the software;
the user end applying for an access of the software;
the software setting an authorization level of the user end;
the user end obtaining the access of the software;
the user end creating one or more records of data in the database by the software;
the user end setting an authorization level of retrieving and storing the data by the software; and
the software retrieving the retrievable data from the database according to the authorization level of each user end, and producing a webpage to output the retrieved data.

2. The method of synchronously providing data from software and website as recited in claim 1, wherein the database comes with a quantity of two or more, and the method further comprises the steps of: storing the plural records of data created by the user end into each database separately, and retrieving the data from each database and producing a webpage to output the retrieved data by the software.

3. The method of synchronously providing data from software and website as recited in claim 1, wherein the authorization level of each user end is defined with a plurality of different priorities, and each authorization level is capable of retrieving data created by the authorization level of the same or lower priority.
